(19) United States
(12) Patent Application Publication
(10) Pub. No.: US 2024/0307719 A1
(43) Pub. Date: Sep. 19, 2024

(54) Wildfire Suppression Assembly

(71) Applicant: Jerry Deville, Compton, CA (US)

(72) Inventor: Jerry Deville, Compton, CA (US)

(21) Appl. No.: 18/123,286

(22) Filed: Mar. 19, 2023

(51) Int. Cl. A62C 3/02; B64D 1/18

(52) U.S. Cl. CPC A62C 3/0242; B64D 1/18; B64C 27/04

(57) ABSTRACT

A wildfire suppression assembly includes an aircraft that has a water reservoir integrated into the aircraft to contain water. A spraying unit is attached to the aircraft to spray the water onto a wildfire over which the aircraft is flying for suppressing the wildfire. A primary reservoir is provided which can be filled with water. A fill hose is fluidly attachable between the primary reservoir and the water reservoir to fill the water reservoir with the water stored in the primary reservoir. A plurality of storage reservoirs has a plurality of fill openings to capture precipitation thereby facilitating each of the storage reservoirs to be filled with the precipitation. Each of the plurality of storage reservoirs is in fluid communication with the primary reservoir to supply the primary reservoir with the water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to wildfire device and more particularly pertains to a new wildfire device for capturing rain water to supply an aircraft with water to spray over a wildfire. The device includes a plurality of storage reservoirs that has fill openings for capturing rain water, a primary reservoir and a pump disposed between the storage reservoirs and the primary reservoir for filling the primary reservoir. A fill hose is included for filling the aircraft with the water from the primary reservoir.

### (2) Description of Related Art Including Information Disclosed Under 37 CFR 1.97 and 1.98.

The prior art relates to wildfire devices including a fire suppression cart that includes a water storage tank and a monitor for spraying the water. The prior art discloses an emergency water reservoir device that includes a storage reservoir that is plumbed to a water supply, a supply pump for pumping the water from the storage reservoir and an infusion pump for pumping treatment chemicals into the water. The prior art discloses a fire protection system for a building that includes a roof supported by rafters, a water storage tank and distribution pipes routed between the water storage tank and the roof. The prior art discloses stand-by water tank that has grappling points to facilitate the water tank to be transported to a fire. The prior art discloses a wildfire suppression system that includes a water tank, a standby generator and a water pump.

### BRIEF SUMMARY OF THE INVENTION

An embodiment of the disclosure meets the needs presented above by generally comprising an aircraft that has a water reservoir integrated into the aircraft to contain water. A spraying unit is attached to the aircraft to spray the water onto a wildfire over which the aircraft is flying for suppressing the wildfire. A primary reservoir is provided which can be filled with water. A fill hose is fluidly attachable between the primary reservoir and the water reservoir to fill the water reservoir with the water stored in the primary reservoir. A plurality of storage reservoirs has a plurality of fill openings to capture precipitation thereby facilitating each of the storage reservoirs to be filled with the precipitation. Each of the plurality of storage reservoirs is in fluid communication with the primary reservoir to supply the primary reservoir with the water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a storage reservoir of an embodiment of the disclosure.

FIG. 2 is a top view of a storage reservoir an embodiment of the disclosure.

FIG. 3 is a cross sectional view taken along line 3-3 of FIG. 2 of an embodiment of the disclosure.

FIG. 4 is a perspective view of a wildfire suppression assembly according to an embodiment of the disclosure.

FIG. 5 is a perspective in-use view of a primary reservoir and an aircraft of an embodiment of the disclosure.

FIG. 6 is a perspective in-use view of an aircraft of an embodiment of the disclosure.

### DETAILED DESCRIPTION OF THE INVENTION

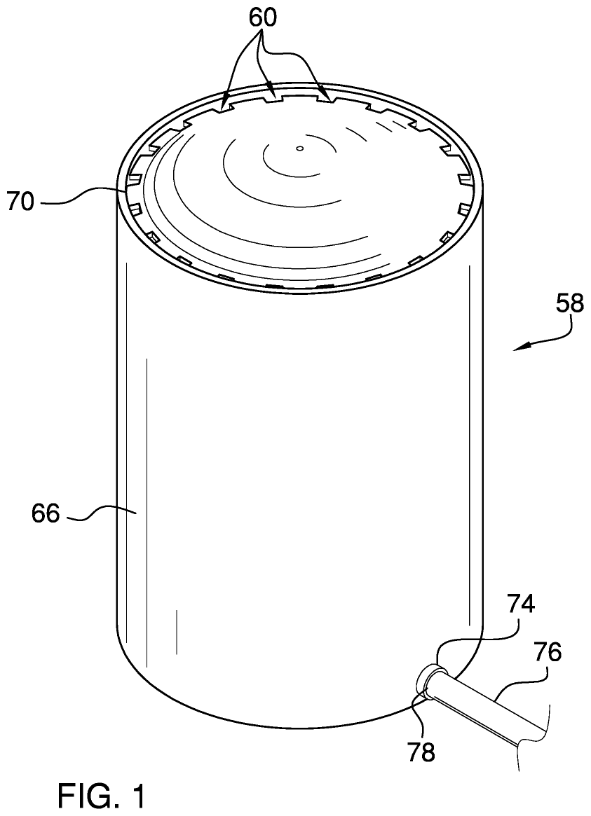

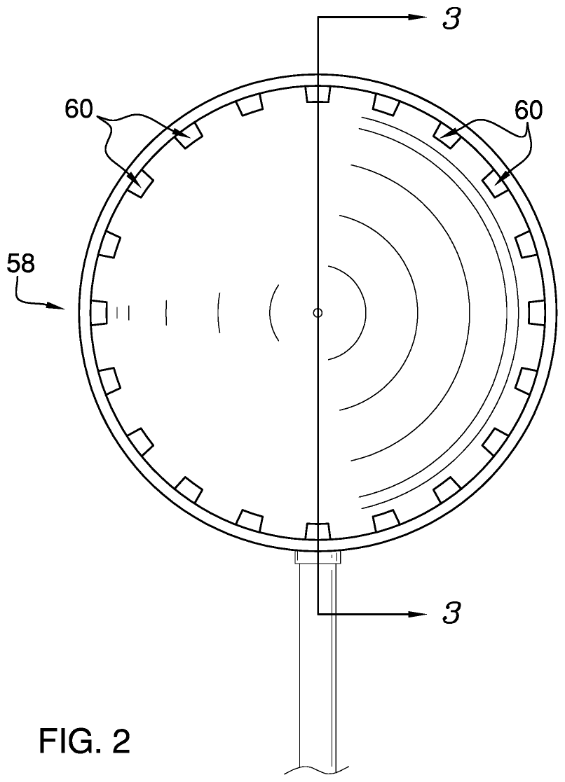

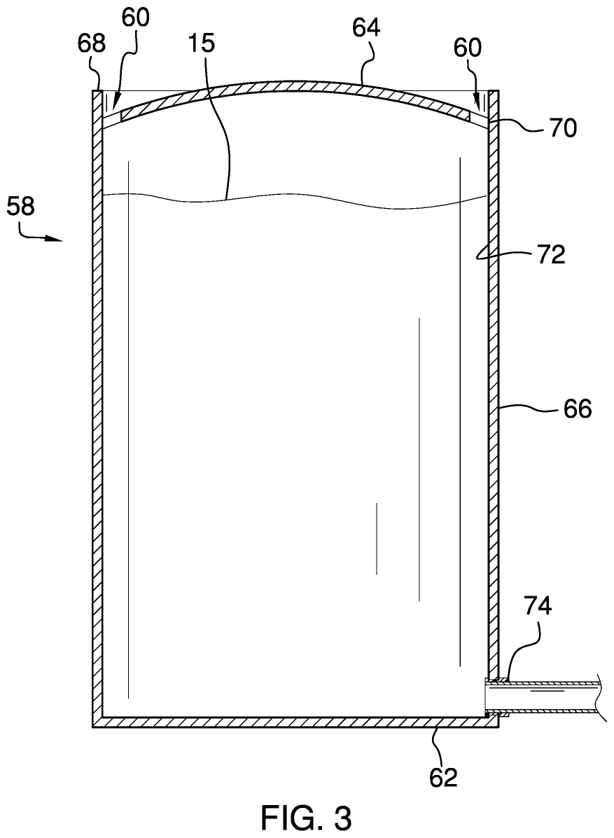

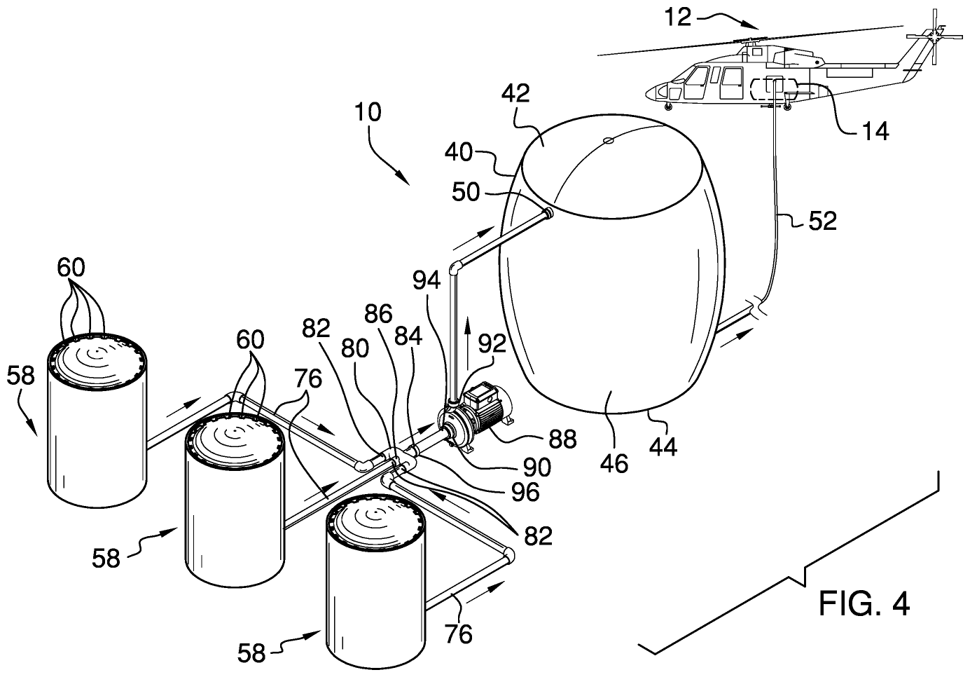

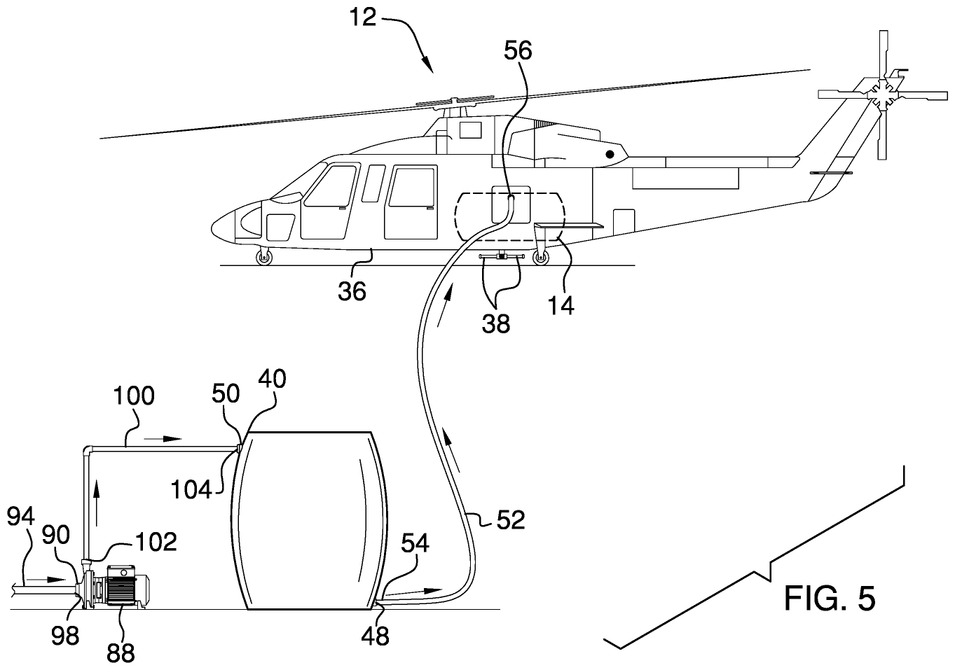

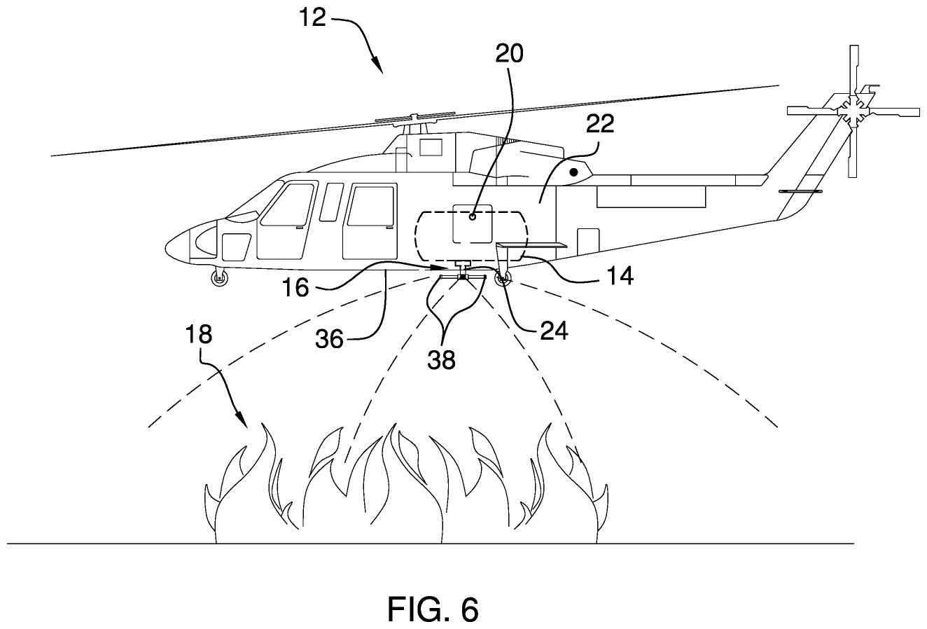

With reference now to the drawings, and in particular to FIGS. 1 through 6 thereof, a new wildfire device embodying the principles and concepts of an embodiment of the disclosure and generally designated by the reference numeral 10 will be described.

As best illustrated in FIGS. 1 through 6, the wildfire suppression assembly 10 generally comprises an aircraft 12 that has a water reservoir 14 integrated into the aircraft 12 such that the water reservoir 14 can contain water 15. The aircraft 12 has a spraying unit 16 which is attached to the aircraft 12 and the spraying unit 16 is in fluid communication with the water reservoir 14. In this way the spraying unit 16 can spray the water 15 onto a wildfire 18 over which the aircraft 12 is flying for suppressing the wildfire 18. The aircraft 12 has a filling port 20 that is integrated into an outer wall 22 of the aircraft 12 and the filling port 20 is in fluid communication with the water reservoir 14. The spraying unit 16 includes a central shaft 24 extending downwardly from a bottom side 36 of the outer wall 22 of the aircraft 12. Additionally, the spraying unit 16 includes a plurality of vanes 38 radiating outwardly from the central shaft 24 such that the vanes 38 are spaced from the bottom side 36 of the outer wall 22 of the aircraft 12. The aircraft 12 may comprise a helicopter of any conventional design that has a payload sufficient to carry at least 30,000.0 liters of water 15.

A primary reservoir 40 is included which can be filled with water 15 and the primary reservoir 40 has a top wall 42, a bottom wall 44 and an outer wall 46 extending between the top wall 42 and the bottom wall 44. The outer wall 46 curves outwardly between the top wall 42 and the bottom wall 44 and each of the top wall 42 and the bottom wall 44 lies on a plane that is oriented parallel with each other. The primary reservoir 40 has an outlet port 48 that is integrated into the outer wall 46 at a point that is positioned closer to the bottom wall 44 than the top wall 42. The primary reservoir 40 has an inlet port 50 that is integrated into the outer wall 46 at a point which is located closer to the top wall 42 than the bottom wall 44. Furthermore, the outlet port 48 is positioned on an opposing side of the outer wall 46 with respect to the inlet port 50. The primary reservoir 40 may have a height ranging between approximately 25.0 meters and 30.0 meters and a diameter ranging between approximately 10.0 meters and 15.0 meters.

A fill hose 52 is provided and the fill hose 52 is fluidly attachable between the primary reservoir 40 and the water reservoir 14 in the aircraft 12. In this way the fill hose 52 can fill the water reservoir 14 with the water 15 stored in the primary reservoir 40. The fill hose 52 has a first end 54 that is fluidly attached to the outlet port 48 in the outer wall 46 of the primary reservoir 40 and the fill hose 52 has a second end 56 that is fluidly attachable to the filling port 20 in the outer wall 46 of the aircraft 12.

A plurality of storage reservoirs 58 is provided and each of the storage reservoirs 58 has a plurality of fill openings 60 that are exposed. Each of the fill openings 60 in each of the storage reservoirs 58 can capture precipitation thereby facilitating each of the storage reservoirs 58 to be filled with water 15. Additionally, each of the plurality of storage reservoirs 58 is in fluid communication with the primary reservoir 40. In this way each of the plurality of storage reservoirs 58 can supply the primary reservoir 40 with the water 15. Each of the storage reservoirs 58 has a lower wall 62, an upper wall 64 and an exterior wall 66 extending upwardly from the upper wall 64 and the exterior wall 66 has a top edge 68. The upper wall 64 has a perimeter edge 70 that is bonded to an interior surface 72 of the exterior wall 66 at a point that is spaced downwardly from the top edge 68. In this way the upper wall 64 can collect the precipitation. The upper wall 64 curves upwardly from the perimeter edge 70 such that the upper wall 64 forms a dome to direct the precipitation toward the perimeter edge 70.

Each of the fill openings 60 associated with a respective one of the storage reservoirs 58 extends through the upper wall 64 associated with the respective storage reservoir 58. Additionally, each of the plurality of fill openings 60 associated with the respective storage reservoir 58 extends from the perimeter edge 70 of the upper wall 64 of the respective storage reservoir 58 toward an apex of the upper wall 64 of the respective storage reservoir 58. The plurality of fill openings 60 are spaced apart from each other and are distributed around the perimeter edge 70 of the upper wall 64. Each of the storage reservoirs 58 has an exhaust port 74 extending through the exterior wall 66 at a point that is located adjacent to the lower wall 62. Additionally, each of the storage reservoirs 58 may have a height ranging between approximately 12.0 meters and 15.0 meters and a diameter ranging between approximately 15.0 meters and 20.0 meters.

A plurality of exhaust conduits 76 is provided and each of the exhaust conduits 76 has a primary end 78 that is fluidly coupled to the exhaust port 74 in the exterior wall 66 of a respective one of the storage reservoirs 58. In this way each of the plurality of exhaust conduits 76 can receive the water 15 in the respective storage reservoirs 58. A manifold 80 is provided which has a plurality of inlets 82 and an outlet 84. A secondary end 86 of each of the plurality of exhaust conduits 76 is fluidly coupled to a respective one of the plurality of inlets 82 of the manifold 80. In this way the manifold 80 receives the water 15 from the plurality of exhaust conduits 76.

A pump 88 is provided which has an intake 90 and an exhaust 92 and the pump 88 has a direction of flow moving from the intake 90 toward the exhaust 92 when the pump 88 is turned on. The pump 88 may comprise an electric fluid pump which has an output capacity of at least 4000.0 liters per minute. An intake pipe 94 is provided which has a first end 96 that is fluidly coupled to the outlet 84 of the manifold 80 such that the intake pipe 94 receives the water 15 from the manifold 80. A second end 98 of the intake pipe 94 is fluidly coupled to the intake 90 of the pump 88 to urge the water 15 outwardly through the exhaust of the pump 88 when the pump 88 is turned on. A supply pipe 100 is provided that has a first end 102 which is fluidly coupled to the exhaust of the pump 88 to receive the water 15 from the pump 88. The supply pipe 96 has a second end 104 that is fluidly coupled to inlet port 50 in the outer wall 46 of the primary reservoir 40. In this way the pump 88 can pump the water 15 into the primary reservoir 40.

In use, each of the storage reservoirs 58 is positioned in strategic locations to facilitate the storage reservoirs 58 to collect rainwater, or snow, thereby facilitating the storage reservoirs 58 to be filled with water 15. The pump 88 is turned on to facilitate the primary reservoir 40 to be filled with the water 15 stored in the storage reservoirs 58. In this way the water reservoir 14 in the aircraft 12 can be refilled many times with the water 15 in the primary reservoir 40 during the course of fighting a wildfire 18. Thus, the aircraft 12 can employ rainwater to suppress wildfires 18 rather than employing a municipal water source, for example, or other source of water that is typically employed to supply drinking water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wildfire suppression assembly for facilitating an aircraft to be filled with rainwater thereby facilitating the aircraft to subsequently release the rainwater onto a wildfire, said assembly comprising:
an aircraft having a water reservoir integrated into said aircraft wherein said water reservoir is configured to contain water, said aircraft having a spraying unit being attached to said aircraft, said spraying unit being in fluid communication with said water reservoir wherein said spraying unit is configured to spray the water onto a wildfire over which said aircraft is flying for suppressing the wildfire;
a primary reservoir being configured to be filled with water;
a fill hose being fluidly attachable between said primary reservoir and said water reservoir in said aircraft wherein said fill hose is configured to fill said water reservoir with the water stored in said primary reservoir; and
a plurality of storage reservoirs, each of said storage reservoirs having a plurality of fill openings being exposed wherein each of said fill openings in each of said storage reservoirs is configured to capture precipitation thereby facilitating each of said storage reservoirs to be filled with the precipitation, each of said plurality of storage reservoirs being in fluid communication with said primary reservoir wherein each of said plurality of storage reservoirs is configured to supply said primary reservoir with the water.

2. The assembly according to claim 1, wherein said aircraft has a filling port being integrated into an outer wall of said aircraft, said filling port being in fluid communication with said water reservoir, said spraying unit including a central shaft extending downwardly from a bottom side of said outer wall of said aircraft, said spraying unit including a plurality of vanes radiating outwardly from a central shaft such that said vanes are spaced from said bottom side of said outer wall of said aircraft.

3. The assembly according to claim 2, wherein:
said primary reservoir has a top wall, a bottom wall and an outer wall extending between said top wall and said bottom wall, said outer wall curving outwardly between said top wall and said bottom wall, each of said top wall and said bottom wall lying on a plane being oriented parallel with each other, said primary reservoir having an outlet port being integrated into said outer wall at a point being positioned closer to said bottom wall than said top wall, said primary reservoir having an inlet port being integrated into said outer wall at a point being located closer to said top wall than said bottom wall, said outlet port being positioned on an opposing side of said outer wall with respect to said inlet port; and
said fill hose has a first end being fluidly attached to said outlet port in said outer wall of said primary reservoir, said fill hose having a second end being fluidly attachable to said filling port in said outer wall of said aircraft.

4. The assembly according to claim 1, wherein:
each of said storage reservoirs has a lower wall, an upper wall and an exterior wall extending upwardly from said upper wall, said exterior wall having a top edge, said upper wall having a perimeter edge being bonded to an interior surface of said exterior wall at a point being spaced downwardly from said top edge wherein said upper wall is configured to collect the precipitation; and
said upper wall curves upwardly from said perimeter edge such that said upper wall forms a dome wherein said upper wall is configured to direct the precipitation toward said perimeter edge; and
each of said storage reservoirs has an exhaust port extending through said exterior wall at a point being located adjacent to said lower wall.

5. The assembly according to claim 4, wherein each of said fill openings associated with a respective one of said storage reservoirs extends through said upper wall associated with said respective storage reservoir, each of said plurality of fill openings associated with said respective storage reservoir extending from said perimeter edge of said upper wall of said respective storage reservoir toward an apex of said upper wall of said respective storage reservoir, said plurality of fill openings being spaced apart from each other and being distributed around said perimeter edge of said upper wall.

6. The assembly according to claim 4, further comprising:
a plurality of exhaust conduits, each of said exhaust conduits having a primary end being fluidly coupled to said exhaust port in said exterior wall of a respective one of said storage reservoirs wherein each of said plurality of exhaust conduits is configured to receive the water in said respective storage reservoirs; and
a manifold having a plurality of inlets and an outlet, a secondary end of each of said plurality of exhaust conduits being fluidly coupled to a respective one of said plurality of inlets of said manifold wherein said manifold is configured to receive the water from said plurality of exhaust conduits.

7. The assembly according to claim 6, wherein:
said primary reservoir has an outer wall, said primary reservoir having an inlet port being fluidly integrated into said outer wall;
said assembly includes a pump having an intake and an exhaust, said pump having a direction of flow moving from said intake toward said exhaust when said pump is turned on;
said assembly includes an intake pipe having a first end being fluidly coupled to said outlet of said manifold wherein said intake pipe is configured to receive the water from said manifold, a second end of said intake pipe being fluidly coupled to said intake of said pump wherein said pump is configured to urge the water outwardly through said exhaust of said pump when said pump is turned on; and
said assembly includes a supply pipe having a first end being fluidly coupled to said exhaust of said pump wherein said supply pipe is configured to receive the water from said pump, said supply pipe having a second end being fluidly coupled to inlet port in said outer wall of said primary reservoir wherein said pump is configured to pump the water into said primary reservoir.

8. A wildfire suppression assembly for facilitating an aircraft to be filled with rainwater thereby facilitating the aircraft to subsequently release the rainwater onto a wildfire, said assembly comprising:
an aircraft having a water reservoir integrated into said aircraft wherein said water reservoir is configured to contain water, said aircraft having a spraying unit being attached to said aircraft, said spraying unit being in fluid communication with said water reservoir wherein said spraying unit is configured to spray the water onto a wildfire over which said aircraft is flying for suppressing the wildfire, said aircraft having a filling port being integrated into an outer wall of said aircraft, said filling port being in fluid communication with said water reservoir, said spraying unit including a central shaft extending downwardly from a bottom side of said outer wall of said aircraft, said spraying unit including a plurality of vanes radiating outwardly from a central shaft such that said vanes are spaced from said bottom side of said outer wall of said aircraft;
a primary reservoir being configured to be filled with water, said primary reservoir having a top wall, a bottom wall and an outer wall extending between said top wall and said bottom wall, said outer wall curving outwardly between said top wall and said bottom wall, each of said top wall and said bottom wall lying on a plane being oriented parallel with each other, said primary reservoir having an outlet port being integrated into said outer wall at a point being positioned closer to said bottom wall than said top wall, said primary reservoir having an inlet port being integrated into said outer wall at a point being located closer to said top wall than said bottom wall, said outlet port being positioned on an opposing side of said outer wall with respect to said inlet port;
a fill hose being fluidly attachable between said primary reservoir and said water reservoir in said aircraft wherein said fill hose is configured to fill said water reservoir with the water stored in said primary reservoir, said fill hose having a first end being fluidly attached to said outlet port in said outer wall of said primary reservoir, said fill hose having a second end being fluidly attachable to said filling port in said outer wall of said aircraft;
a plurality of storage reservoirs, each of said storage reservoirs having a plurality of fill openings being exposed wherein each of said fill openings in each of said storage reservoirs is configured to capture precipitation thereby facilitating each of said storage reservoirs to be filled with the precipitation, each of said plurality of storage reservoirs being in fluid communication with said primary reservoir wherein each of said plurality of storage reservoirs is configured to supply said primary reservoir with the water, each of said storage reservoirs having a lower wall, an upper wall and an exterior wall extending upwardly from said upper wall, said upper wall having a top edge, said upper wall having a perimeter edge being bonded to an interior surface of said exterior wall at a point being spaced downwardly from said top edge wherein said upper wall is configured to collect the precipitation, said upper wall curving upwardly from said perimeter edge such that said upper wall forms a dome wherein said upper wall is configured to direct the precipitation toward said perimeter edge, each of said fill openings associated with a respective one of said storage reservoirs extending through said upper wall associated with said respective storage reservoir, each of said plurality of fill openings associated with said respective storage reservoir extending from said perimeter edge of said upper wall of said respective storage reservoir toward an apex of said upper wall of said respective storage reservoir, said plurality of fill openings being spaced apart from each other and being distributed around said perimeter edge of said upper wall, each of said storage reservoirs having an exhaust port extending through said exterior wall at a point being located adjacent to said lower wall;
a plurality of exhaust conduits, each of said exhaust conduits having a primary end being fluidly coupled to said exhaust port in said exterior wall of a respective one of said storage reservoirs wherein each of said plurality of exhaust conduits is configured to receive the water in said respective storage reservoirs;
a manifold having a plurality of inlets and an outlet, a secondary end of each of said plurality of exhaust conduits being fluidly coupled to a respective one of said plurality of inlets of said manifold wherein said manifold is configured to receive the water from said plurality of exhaust conduits;
a pump having an intake and an exhaust, said pump having a direction of flow moving from said intake toward said exhaust when said pump is turned on;
an intake pipe having a first end being fluidly coupled to said outlet of said manifold wherein said intake pipe is configured to receive the water from said manifold, a second end of said intake pipe being fluidly coupled to said intake of said pump wherein said pump is configured to urge the water outwardly through said exhaust of said pump when said pump is turned on; and
a supply pipe having a first end being fluidly coupled to said exhaust of said pump wherein said supply pipe is configured to receive the water from said pump, said supply pipe having a second end being fluidly coupled to inlet port in said outer wall of said primary reservoir wherein said pump is configured to pump the water into said primary reservoir.
